(19) United States
(12) Patent Application Publication
(10) Pub. No.: US 2004/0211337 A1
(43) Pub. Date: Oct. 28, 2004

(54) Polishing slurry comprising silica-coated ceria

(76) Inventors: In Yeon Lee, Seoul (KR); Sang Tae Kim, Kyungki-do (KR); Yun Ju Cho, Seoul (KR); Sang Kyu Park, Kyungki-do (KR); Kyoung Jun Kim, Kyungki-do (KR)

Correspondence Address: David A Einhorn, Anderson Kill & Olick, 1251 Avenue of the Americas, New York, NY, 10020, US

(21) Appl. No.: 10/487,522

(22) PCT Filed: Aug. 20, 2002
(86) PCT No.: PCT/KR02/01568

(30) Foreign Application Priority Data
Aug. 20, 2001 (KR) 2001/49925
Dec. 4, 2001 (KR) 2001/76082

(51) Int. Cl. C09K 3/14

(52) U.S. Cl. 106/3; 51/307; 51/308; 51/309; 438/692; 428/693

(57) ABSTRACT

A polishing slurry composition for CMP comprising 0.5 to 5% by weight of a silica-coated ceria powder dispersed in an aqueous medium can be beneficially used in the planarization of the surfaces of various film layers of semi-conductors and electro-luminescent devices.

### FIELD OF THE INVENTION

The present invention relates to a polishing slurry composition comprising a silica-coated ceria (CeO₂) powder as a polishing agent.

### BACKGROUND OF THE INVENTION

Chemical Mechanical Polishing (CMP), a process used for planarizing the surfaces of various inorganic or organic layers of a device by the chemical and mechanical action of polishing agent, conventionally uses a metal oxide, e.g., silica(SiO₂), alumina(Al₂O₃), ceria(CeO₂), zirconia(ZrO₂) and titania(TiO₂), as a polishing agent in an aqueous slurry form.

In the field of a semiconductor or electroluminescent device manufacturing technology, ceria has recently been used in the planarization of a thin film layer due to its good hardness and polishing property.

For example, U.S. Pat. No. 6,238,450 discloses a polishing slurry useful for polishing optical or semiconductor surfaces, which comprises a ceria powder with a BET surface area of at least 10 m²/g, and optional other abrasive particles such as alumina, silica, and zirconia.

Further, U.S. Pat. Nos. 5,772,780 and 6,043,155 teach a polishing agent and a polishing method for polishing the surface of an insulating film constituting a semiconductor integrated circuit or an optical glass element, and specifically discloses a ceria slurry composed of a ceria powder containing Na, Ca, Fe and Cr at a concentration of less than 10 ppm.

U.S. Pat. No. 6,358,853 discloses a ceria slurry comprising two kinds of ceria powders having different particle sizes, and an optional silica powder.

However, ceria particles tends to easily agglomerate when compared to other abrasive particles such as silica and alumina, and thus, in an aqueous slurry system, they have poor dispersability and unsatisfactory long-term storage stability, leading to deteriorated polishing properties.

### SUMMARY OF THE INVENTION

Accordingly, it is a primary object of the present invention to provide a polishing composition comprising non-agglomerating ceria particles having good dispersability and storage stability in an aqueous slurry form, the composition having excellent performance characteristics in polishing the surfaces of various film layers, particularly in the semiconductor and electroluminescent device fields.

In accordance with one aspect of the present invention, there is provided a polishing composition comprising a silica-coated ceria powder as a polishing agent in an aqueous slurry form.

In accordance with another aspect of the present invention, there is provided a method for polishing the surface of a thin film layer of a semiconductor or electroluminescent device using the inventive polishing aqueous slurry composition.

### BRIEF DESCRIPTION OF THE DRAWINGS

The above and other objects and features of the present invention will become apparent from the following description of the invention, when taken in conjunction with the accompanying drawings which respectively show:

FIG. 1: a TEM photograph of the silica-coated ceria particles used in the present invention;

FIG. 2: IR spectra of the silica-coated ceria particles used in the present invention and non-coated ceria particles;

FIGS. 3a and 3b: FE-SEM (Field Emission-Scanning Electron Microscope) photographs of an ITO (indium-tin oxide) layer polished with the aqueous slurries of Example 4 and Comparative Example 3, respectively; and

FIGS. 4a and 4b: AFM (Atomic Force Microscope) photographs of an ITO layer polished with the aqueous slurries of Example 4 and Comparative Example 3, respectively.

### DETAILED DESCRIPTION OF THE INVENTION

The inventive polishing composition is an aqueous slurry comprising a silica-coated ceria powder as a polishing agent, preferably in an amount of 0.5 to 5% by weight.

The silica-coated ceria powder used in the inventive slurry composition may be prepared by reacting an aqueous slurry of ceria powder with an aqueous solution of an alkali metal silicate.

The starting ceria powder used in the aqueous ceria slurry may be commercially available or prepared in a conventional manner, e.g., by a gas phase synthesis method such as gas phase pyrolysis, chemical vapor deposition, evaporation-condensation and oxidation-reduction; a liquid phase synthesis method such as precipitation, solvent evaporation, sol-gel reaction and hydrothermal reaction; and a solid phase synthesis method such as mechanochemical method and pyrolysis.

Since how well dispersed the starting ceria powder is in an aqueous medium would influence the reaction of the ceria with the silicate and the uniformity of the silica coating formed on the ceria particle, it is preferred that the ceria powder is uniformly dispersed by way of a conventional dispersion means including ultrasonic, wet mill and particle collision methods.

Representative examples of the alkali metal silicate are potassium silicate and sodium silicate and the alkali metal silicate is preferably employed in the form of an aqueous solution having a concentration of 0.1 to 3 M.

The reaction of a ceria slurry with an aqueous alkali metal silicate is preferably conducted at a temperature ranging from 60 to 100° C. and a pH of 3 to 10, by adding the alkali metal silicate solution slowly to the ceria slurry at a rate of 0.1 to 2 g/min. When the temperature is lower than 60° C., the reaction time becomes too long, whereas when the temperature is higher than 100° C., the rate of forming the silica layer is difficult to control. The reaction is more preferably conducted at a temperature of about 90° C.

Further, when the pH is greater than 10, the solubility of silica to become too high to form a stable silica coating layer on the ceria particle, and when the pH is below 3, a satisfactory coating does not form.

The reaction is preferably carried out with stirring at a suitable rate so that a silica layer can be uniformly formed on the surface of the ceria particle.

After the completion of the reaction, the resulting slurry is preferably filtered through a cation exchange resin or a filter to remove any remaining alkali components, in order to maintain the electric conductivity of the slurry at below 10 μs. If the electric conductivity of the polishing slurry is too high, the storage stability of the slurry becomes poor, and when the slurry is employed in polishing a conductive layer, the alkali component diffuses into the layer, causing inferior products.

The slurry obtained by the above reaction is dried, e.g., by freeze-drying, to obtain silica-coated ceria particles, or the slurry may be directly employed as a polishing composition.

The thickness of the silica layer formed the ceria particles may preferably range from 0.1 to 10 nm, more preferably 0.1 to 5 nm. If the thickness is less than 0.1 nm, the silica coating layer is unstable and thus it does not impart the desired dispersability to the ceria particles. If the thickness is, on the other hand, greater than 10 nm, the benefits of the ceria particles are not effectuated and the polishing performance deteriorates.

The inventive polishing slurry may optionally comprise a dispersant and an additive for improving the polishing performance. The dispersant may be used in an amount ranging from 0.5 to 10% by weight based on the silica-coated ceria used and it may include a water-soluble organic compound having at least one selected from the group consisting of COOH, COOX, SO₃H, and SO₃X, wherein X is a monovalent radical that is cation-exchangeable with hydrogen. Representative examples of the dispersant are polyacrylic acid, polymethacrylic acid, and ammonium and sulfonic acid salts thereof.

Further, the additive may include an amine containing organic compound such as an alkylamine, e.g., methylamine, and a hydroxylalkylamine, e.g., methanolamine, and it may be added in an amount ranging from 0.1 to 50% by weight, preferably 0.1 to 20% by weight, based on the silica-coated ceria used.

The inventive polishing slurry composition may be suitably maintained at a pH ranging from 4 to 11, preferably from 8 to 11. If the pH of the composition does not fall within the above range, the film substrate being polished is easily oxidized.

The inventive composition for CMP containing the silica-coated ceria particles can be more beneficially used in the planarization of the surfaces of various film layers of semi-conductors and electroluminescent devices.

The present invention is further described and illustrated in the following Examples, which are, however, not intended to limit the scope of the present invention.

Synthesis of Silica-Coated Ceria Particles

Preparation 1

An aqueous slurry containing 10% by weight of a ceria powder having an average particle diameter of about 40 nm was prepared using a particle-impact dispersion equipment (Sukino Machine, HJP-30015; 250 MPa). 390.24 g of the aqueous slurry was placed in a stirred reactor maintained at 90° C. and added slowly thereto was 110.4 g of 1M aqueous sodium silicate solution at a rate of 0.03 g/sec with stirring at 1000 rpm. During the reaction, the pH of the reactant solution was maintained at 9 with 36.5 wt % aqueous HCl. After the completion of the addition, the solution was further stirred for 30 minutes. The resultant slurry was cooled to room temperature, passed through a Tangential Flow Ultra Filtration Filter (Pallsep, PS10VMF; 0.2 μm) to remove sodium ions present in the slurry to below 10 μs, and freeze-dried to obtain silica-coated ceria particles.

Preparations 2 and 3

The procedure of Preparation 1 was repeated except that the concentrations of the sodium silicate solution added were 0.5 M and 2 M, respectively, to obtain silica-coated ceria particles.

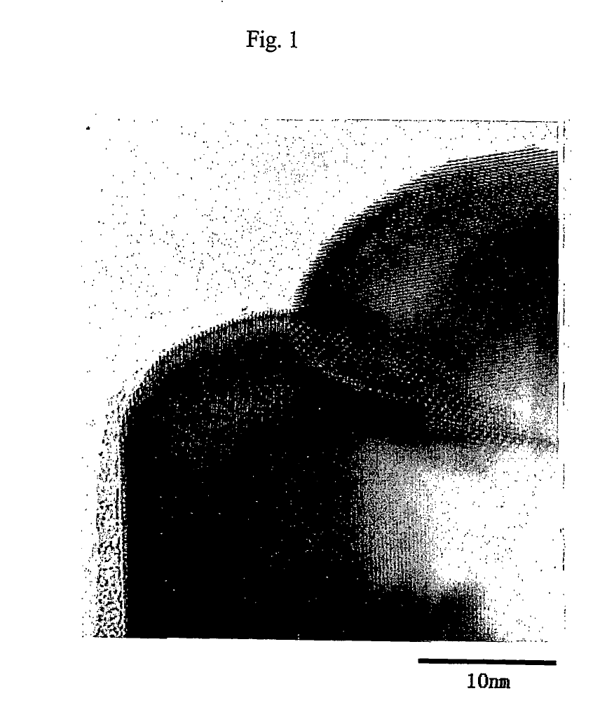

The thickness and the shape of the silica coating of the silica-coated ceria particles thus obtained were evaluated with a TEM(transmission electron microscope) (JEM3010 of JEOL) in ethanol. The results are shown in FIG. 1 and Table 1, which illustrates that a silica coating is uniformly formed on the surface of the ceria particle.

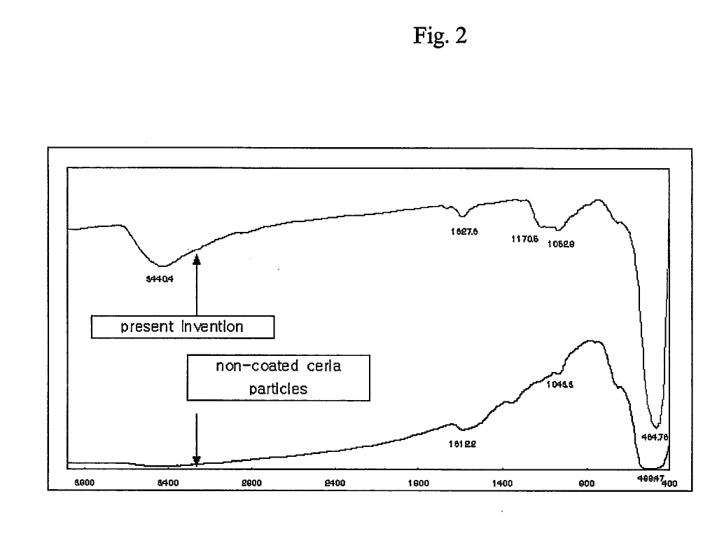

Further, the silica-coated ceria particles obtained above and non-coated ceria particles as a control were analyzed by IR (Infrared Spectrometer; MATTSON 5000 of UNICAM). As shown in FIG. 2, the peaks at 1170.5 cm⁻¹(Si—O) and 3440.4 cm⁻¹(Si—OH), which are absent in non-coated ceria particles, appear in the coated ceria particles. This means that a silica coating is clearly formed on the surface of a ceria particle.

The Si content of the silica-coated ceria particles was measured by ICP (Inductively Coupled Plasma; Polyscan61E of TJA), and represented in Table 1.

In addition, the surface zeta potential and the transmittance percentage of the silica-coated ceria particles obtained above and non-coated ceria particles as a control were measured using aqueous slurries respectively containing each ceria particles with ESA9000 (MATEC) and UV-VIS Spectrophotometer UV-2101PC (SHMAZU). The measurement results are shown in Table 1.

TABLE 1

| | Coating | | | Transmittance (%) | |
|---|---|---|---|---|---|
| | Thickness | Si Content | Surface Zeta | (at 500 nm) | |
| | (nm) | (wt %) | Potential (mV) | Initial | After 30 days |
| Prep. 1 | 1-2 | 1.2 | −50 | 71 | 71 |
| Prep. 2 | 0.1-1 | 0.85 | −48 | 70 | 65 |
| Prep. 3 | 1-5 | 1.2 | −48 | 70 | 63 |
| Control | — | — | 55 | 65 | 30 |

Table 1 shows that the silica-coated ceria particles have superior dispersion stability to that of non-coated ceria particles.

Preparation of Polishing Slurry

### EXAMPLES 1 TO 3

The silica-coated ceria particles obtained in Preparations 1 to 3 were dispersed into deionized water in an amount of 1 wt % by using a particle collision dispersion equipment, to obtain polishing slurries (pH 7) according to the present invention.

### Comparative Example 1

The procedure of Examples 1 to 3 above was repeated except that non-coated ceria particles were employed in place of the coated ceria particles, to obtain a polishing slurry as a control.

### EXAMPLE 4

The silica-coated ceria particles obtained in Preparation 1 were dispersed into deionized water in an amount of 1 wt % by using a particle collision dispersion equipment to obtain a ceria slurry (pH 10) and thereto was added ammonium polyacrylate (Darvan 821A, a product of R.T. Vandervilt) in an amount of 1 wt % based on the coated ceria particles, to obtain a polishing slurry according to the present invention.

### EXAMPLE 5

The procedure of Example 4 was repeated except that triethylamine was further added in an amount of 10 wt % based on the coated ceria particles, to obtain a polishing slurry according to the present invention.

### Comparative Example 2

The procedure of Example 4 was repeated except that non-coated ceria particles were employed in place of the coated ceria particles, to obtain a polishing slurry as a control.

### Comparative Example 3

Aluminum Oxide C (DEGUSSA, Japan) particles were dispersed in deionized water using a particle collision dispersion equipment, to obtain a polishing slurry (pH 3) containing 12 wt % alumina.

Evaluation of Polishing Performance

The polishing performance was evaluated by measuring the polished amount of a silica film layer. The polished amount was determined by polishing the silica layer with each of the polishing slurries obtained in Examples 1 to 3 using Minimet100 (a product of Struers) at room temperature under 6 lbs/cm² and 30 rpm, and then measuring the change in the film thickness after the polishing, with an Ellipsometer(SD2000, Plasmos) and the results are represented in Table 2.

TABLE 2

| | Polished Amount (Å/min) |
|---|---|
| Ex. 1 | 900 |
| Ex. 2 | 850 |
| Ex. 3 | 700 |
| Comp. Ex. 1 | 400 |

As can be seen from Table 2, the silica-coated ceria particles used in accordance with the present invention have superior polishing performance to that of non-coated ceria particles.

Further, the polishing performances of the polishing slurries obtained in Examples 4 and 5, and Comparative Examples 2 and 3 were evaluated by polishing an ITO (indium-tin oxide) film layer formed on a glass plate using Lapmaster LGP381 (a produce of Lapmaster) at room temperature under a pressure of 150 kg_{f}/cm², feeding the polishing slurry at a rate of 150 ml/min. The change in the film thickness and the non-uniformity of the polished film were measured with CMT-SR2000N (CHANGMIN TECH of Korea), and the surface characteristics and the appearance of the polished surface were analyzed with an AFM (Atomic Force Microscope) and an FE-SEM (Field Emission-Scanning Electron Microscope; JSM6700F of JEOL), respectively.

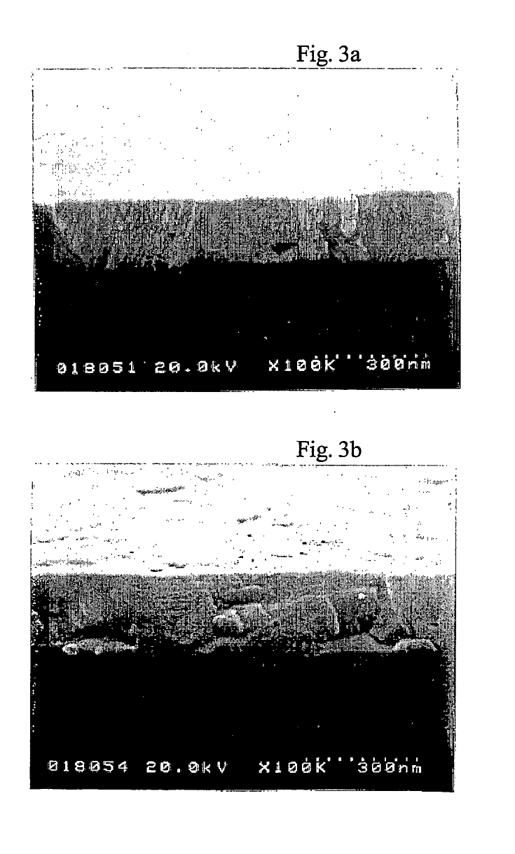

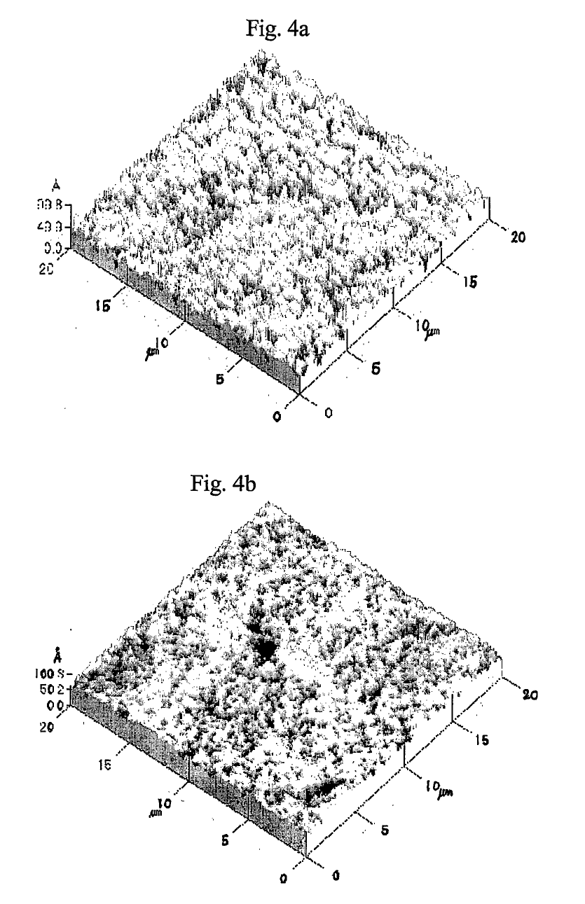

The results are represented in Table 3, and FE-SEM photographs and AFM photographs of the ITO film layer polished with the aqueous slurries of Example 4 and Comparative Example 3 are represented in FIGS. 3a and 3b, and FIGS. 4a and 4b, respectively.

TABLE 3

| | | | Amount | Non- | Surface | Height from | |
|---|---|---|---|---|---|---|---|
| | | Dispersant or | Polished | uniformity | Roughness | peak to valley | Surface |
| | Abrasive | Additive | (Å/min) | (%) | (Rrms)(Å) | (Rp-v)(Å) | Appearance |
| Ex. 4 | Silica-coated | Ammonium | 130 | 3.2 | 8.8 | 76.9 | Good |
| | ceria | polyacrylate | | | | | |
| Ex. 5 | Silica-coated | Ammonium | 151 | 2.8 | 6.5 | 62.3 | Good |
| | ceria | polyacrylate + | | | | | |
| | | Trimethylamine | | | | | |
| Comp. Ex. 2 | Non-coated | Ammonium | 120 | 6.7 | 12.1 | 120 | Good |
| | ceria | polyacrylate | | | | | |
| Comp. Ex. 3 | Alumina | — | 32 | 6.3 | 22 | 232 | Some |
| | | | | | | | scratches |

The results in Table 3 and FIGS. 3 and 4 show that when the silica-coated ceria particles are used in a polishing slurry in accordance with the present invention, they can provide better polishing performance than non-coated ceria particles.

While some of the preferred embodiments of the subject invention have been described and illustrated, various changes and modifications can be made therein without departing from the spirit of the present invention defined in the appended claims.

1. A polishing slurry composition comprising 0.5 to 5% by weight of a silica-coated ceria powder dispersed in an aqueous medium.

2. The composition of claim 1, further comprising 0.5 to 10% by weight of a dispersant based on the silica-coated ceria used.

3. The composition of claim 2, wherein the dispersant is a water-soluble organic compound having at least one selected from the group consisting of COOH, COOX, SO₃H, and SO₃X, X being a monovalent radical which is cation-exchangeable with hydrogen.

4. The composition of claim 3, wherein the dispersant is selected from the group consisting of polyacrylic acid, polymethacrylic acid, and ammonium and sulfonic acid salts thereof.

5. The composition of claim 1, further comprising 0.1 to 50% by weight of an amine group containing organic compound selected from an alkylamine and a hydroxylalkylamine, based on the silica-coated ceria used.

6. The composition of claim 1, wherein the pH of the composition ranges from 4 to 11.

7. The composition of claim 1, wherein the electric conductivity of the composition is below 10 μs.

8. The composition of claim 1, wherein the silica-coated ceria is prepared by reacting an aqueous ceria slurry with an aqueous alkali metal silicate solution and passing the reaction product solution through a filter or a cation exchange resin to remove the alkali component contained therein.

9. The composition of claim 1, wherein the silica coating formed on ceria particles has a thickness of 0.1 to 10 nm.

10. A method for polishing the surface of a thin film layer of a semiconductor or electroluminescent device using the polishing slurry composition recited in claim 1.

11. A method for polishing the surface of a thin film layer of a semiconductor or electroluminescent device using the polishing slurry composition recited in claim 2.

12. A method for polishing the surface of a thin film layer of a semiconductor or electroluminescent device using the polishing slurry composition recited in claim 3.

13. A method for polishing the surface of a thin film layer of a semiconductor or electroluminescent device using the polishing slurry composition recited in claim 4.

14. A method for polishing the surface of a thin film layer of a semiconductor or electroluminescent device using the polishing slurry composition recited in claim 5.

15. A method for polishing the surface of a thin film layer of a semiconductor or electroluminescent device using the polishing slurry composition recited in claim 6.

16. A method for polishing the surface of a thin film layer of a semiconductor or electroluminescent device using the polishing slurry composition recited in claim 7.

17. A method for polishing the surface of a thin film layer of a semiconductor or electroluminescent device using the polishing slurry composition recited in claim 8.

18. A method for polishing the surface of a thin film layer of a semiconductor or electroluminescent device using the polishing slurry composition recited in claim 9.
